(19) United States
(12) Patent Application Publication
(10) Pub. No.: US 2008/0116883 A1
(43) Pub. Date: May 22, 2008

(54) Inductive sensor for sensing of two coupling elements

(76) Inventor: Stefan Ruehl, Luenen (DE)

Correspondence Address: MILDE & HOFFBERG, LLP, 10 BANK STREET, SUITE 460, WHITE PLAINS, NY, 10606, US

(21) Appl. No.: 11/986,372

(22) Filed: Nov. 21, 2007

(30) Foreign Application Priority Data
Nov. 22, 2006 (DE) 10 2006055409.42

(51) Int. Cl. G01B 7/14

(52) U.S. Cl. 324/207.17

(57) ABSTRACT

In an inductive sensor device, and a method for inductive identification, a first and a second exciter inductor 16a, 16b extend along a measurement range and vary spatially differently from each other. A first and a second inductive coupling element 12a, 12b couple a signal from the exciter inductors 16a, 16b into a receiver inductor 18. The inductive coupling elements 12a, 12b are formed as resonance elements with a first resonance frequency f1 and a second resonance frequency f2. In order to be able to simply determine the position of both inductive coupling elements quickly and accurately, the two exciter inductors are driven by different transmission signals S1, S2. Each of the transmission signals includes signal components of a first carrier frequency near the first resonance frequency f1 varying in temporal progression, and of a second carrier frequency near the second resonance frequency f2 varying in temporal progression.

The invention relates to an inductive sensor device and a method for inductive identification. Particularly, the invention relates to a sensor device and a pertinent method in which a signal from at least one exciter inductor is tightly coupled by means of at least two coupling elements into at least one receiver inductor, and the positions of the coupling elements are determined from the receiver inductor signal received at the receiver inductor.

Such inductive sensors to determine a position or derived values (e.g., velocity) are known in many forms for a multitude of applications. They determine the position of an inductive coupling element within a measurement range that, for example, may be linear, circular, or arc-shaped. The measurement range may be mono- or multi-dimensional. The transmitter and the receiver inductor(s) extend along the measurement range such that at least one of the inductors varies spatially, which leads to a position-dependent coupling by means of the coupling element. The exciter inductor(s) is/are driven by alternating current, which leads to the creation of a magnetic alternating field at the exciter inductor(s). The coupling element positioned within the range of this field tightly couples this signal into the receiver inductor.

The Patent Publication No. WO 2003/038379 describes an inductive sensor by means of which the relative position of a coupling element may be determined with respect to an inductor circuit. The inductor circuit includes a first varying exciter inductor (sine inductor) varying spatially over the measurement range; a second exciter inductor (cosine inductor) varying spatially but different from the first exciter inductor, and a receiver inductor. The exciter inductors are so shaped that they create a magnetic field varying sinusoidally along the measurement range, whereby the progression of the fields created by the two inductors is phase-displaced. The coupling element is configured as a resonance circuit with a specific resonance frequency.

The exciter inductors are excited by means of transmission signals. These correspond to a carrier signal whose frequency matches the resonance frequency of the coupling element and is modulated using a modulation signal of a clearly lower modulation frequency. Transmission signals that are phase-displaced with respect to the modulation frequency are provided to the two exciter inductors. By excitation of the coupling element to its resonance frequency, a resonance signal with increased amplitude arises whose phase is dependent on the various components of the excitation by the sine and cosine inductor, and thereby on its position within the measurement range. The receiver inductor signal is received by the receiver inductor and is processed in that it is demodulated and the phase of the signal components is observed. From this, the position of the coupling element may be determined.

The Patent Publication No. WO 2003/038379 specifies that several pairs of exciter inductors may be provided in order to enable two-dimensional determination. Several resonance circuits may be provided as coupling elements that differ by resonance frequency.

The Patent Publication No. WO 2004/072653 describes a device and a method to determine the position or velocity of an object whereby measurement errors that may arise under the method described in the aforementioned WO 2003/038379 may be prevented. Here also, a resonance frequency is excited by means of a sine and a cosine inductor with a modulated signal, and the phase of the resulting signal is evaluated with respect to the modulation frequency. The transmission signals at the exciter inductors contain frequency components of a first carrier frequency in the range of the resonance frequency of the coupling element, and a second carrier frequency that clearly deviates from the resonance frequency. Signal components of both carrier frequencies are modulated by the modulation frequency. While the signal components of the resonance frequency lead to resonance at the coupling element, and thus to a strong receiver inductor signal from which the position may be determined, the signal components at the second carrier frequency serve to provide the ability to evaluate and eliminate the noise level in the received signal.

European Patent No. EP 1 666 836 describes an inductive sensor with which the absolute or relative rotational position of two rotatable rotor elements that are mounted at distance from each other on shaft segments of a shaft so that they may rotate may be determined with respect to a stator element. The shaft segments are connected together elastically so that the torque may be determined by the relative excursion. An inductor circuit is provided on the stator element to determine the rotational position of the rotor elements that extends along the sensor range about the rotor elements. The rotor elements include inductive coupling elements that are formed as resonance circuits with differing resonance frequencies that make them distinguishable.

The sensor functions according to the principle described in the aforementioned WO 2003/038379. It is provided that, in order to determine the positions of both coupling elements the inductor circuit may either include two axially-separated, ring-shaped inductors structures, each of which is assigned to a rotor element and excite them to their individual resonance frequencies, or that an inductor circuit may be provided with a common inductor structure for both coupling elements. In the latter case, the inductors are then excited first with the one and then with the other resonance frequency to be temporally displaced so that the positions of both coupling elements may be determined in sequence.

It is the objective of the invention to provide an inductive sensor device and a determination method by means of which the positions of two inductive coupling elements may be determined simply, quickly, and accurately.

This objective is achieved by a device per patent claim 1 and a method per claim 8. The Dependent claims relate to advantageous embodiments of the invention.

According to the invention, at least two exciter inductors that extend over a measurement range with spatial variation are excited by two varying transmitter signals. Two inductive coupling elements are configured as resonance elements, whereby the first inductive coupling element possesses a first resonance frequency, and the second inductive possesses a second resonance frequency. The coupling elements serve to tightly couple a signal from the exciter inductors into at least one receiver inductor.

The transmission signals contain signal segments with alternating temporal sequence components of a first and of a second carrier frequency. These carrier frequencies are so selected that they essentially correspond to the resonance frequencies of the two coupling elements. If a differences still exists between the exact resonance frequency of one of the coupling elements and the pertinent carrier frequency because, for example, of inaccuracy or drift, then the carrier frequency should still be so close to the resonance frequency that a clear increase in resonance results.

The transmission signals of the two exciter inductors differ in that the temporal progression by means of which the signal components of the two carrier frequencies alternate is different between the two transmission signals.

The present invention distinguishes itself from earlier sensor systems such as that described in the European Patent No. EP 1 666 836, in which the entire device, i.e., both exciter inductors are driven in turn with the two carrier frequencies. Although determination of each of the two coupling elements may result only intermittently and with great temporal separation, the solution according to the invention allows a more narrow temporal progression up to a continuous, simultaneous determination of the position of both coupling elements.

The basic design of both inductors, known from the Patent Publication No. WO 2003/038379 may be used for the determination of the position of two coupling elements; i.e., no additional inductors are required. It may, however, be preferable to provide a second receiver inductor. As is shown within the scope of the preferred embodiment, both the creation of corresponding transmission signals and the evaluation of a common receiver inductor signal are simple to ensure. The method is suited very well for conversion with the help of digital signal processing.

The exact determination of the positions of two coupling elements electrically distinguishable by the deviating resonance frequency is advantageous to a large number of applications. On the one hand, the desired degree of redundancy may be achieved for critical safety applications. For example, for automotive sensors, the two coupling elements may be mounted jointly on an element to be determined so that two measurement values for the position of this element are determined (and if one of the coupling elements fails, the correct value is still available). On the other hand, the positions of two elements, each of which is configured with one of the coupling elements, may be determined simultaneously, so that the expense of necessary inductors is reduced, and so that differential measurements such as are necessary for torque determination are possible.

For this, the transmission signals may include in various ways the signal components of both carrier frequencies alternating in temporal progression. The alternating temporal progression preferably relates to the amplitude of each of the signal components.

According to an extension of the invention, the signal components in the two transmission signals are altered according to a common modulation frequency. However, the alteration in the two transmission signals with respect to phase of this modulation frequency is different. The modulation frequency determines the alteration with which the components (preferably, amplitude) in the first carrier frequency change with respect to the second carrier frequency. Since each temporal progression of the two transmission signals is known, it may be recognized during signal evaluation as to which components of the receiver inductor signal may be derived from a (phase-matched or phase-opposite) coupling with the first inductor, and which may be derived from a coupling with the second inductor. From this and from the knowledge of the spatial variation of the exciter inductors (preferably so that a periodically-varying, and especially so that a sine-shaped spatial progression results), the positions of each of the coupling elements responsible for the coupling and frequency-selective may be determined.

According to a particularly advantageous extension of the invention, the transmission signals are formed as a temporally sequential first and second signal extract, whereby the first signal extracts are formed as oscillations of the first carrier frequency, and the second signal extracts are formed as oscillations of the second carrier frequency. Each of the signal extracts may also contain other frequency components, e.g., harmonic oscillations. In this advantageous configuration, there are no components of the second carrier frequency in the first signal extract, and vice versa, there are no components of the first carrier frequency in the second signal extract. The progression of signal extracts results with the modulation frequency that is advantageously clearly lower than the carrier frequencies, e.g., by a factor or 10 or more, and preferably 100 or more. The signal extracts between the two transmission signals are hereby temporally displaced (which corresponds to a phase shift with respect to the modulation frequency). While other phase shifts are possible, it is particularly advantageous if the phase shift is so selected that the change from a first signal extract to a second signal extract within the first exciter inductor corresponds temporally to a central section of a first or second signal extract at the second inductor. This ensures that a particularly narrow time-progression interlace is achieved. Particularly advantageous is a digital modulation in which two signal extracts are positioned in one period of the modulation frequency. Of these, the first and the second are of differing frequency. Phase shift between the transmission signals of the two exciter inductors preferably is 90°, with respect to the modulation frequency.

Regarding signal evaluation, an extension of the invention provides that the (at least one) receiver inductor is connected to an evaluation unit. This unit determines from the receiver inductor signal the position of the coupling elements. This evaluation unit is so configured that the receiver inductor signal is demodulated in order to obtain a first and a second demodulated signal whose frequency essentially corresponds to the modulation frequency. The first and the second demodulated signal correspond here to the temporal progression of the signal components for the first and the second carrier frequency. The position of each of the assigned coupling elements may be determined from the phase of each of the demodulated signals. The demodulation may advantageously result through synchronous detection, whereby a complementary signal of each of the carrier frequencies is used. Alternatively, other demodulation procedures are applicable. It is possible that only one receiver inductor is connected to the evaluation unit, whereby the position of both coupling elements received there may be determined. It is preferred that two separate receiver inductors are connected to the evaluation unit, whereby the position of the first coupling element may be determined from the signal received in the first receiver inductor signal, and the position of the second coupling element may be determined from the signal received in the second receiver inductor signal.

To determine the position of a motion element with respect to a stator element, it is preferred that the stator element include an inductor circuit with the exciter inductors and the receiver inductor. The inductor circuit is preferably formed to be flat in a carrier, e.g., on a circuit board or a flexible material, and may contain additional inductors. At least one of the inductive coupling elements is mounted on an element that moves with respect to the stator element. The exciter inductors are connected to a signal generator to create and conduct the transmission signals. The receiver inductor is connected to an evaluation unit used to evaluate the receiver inductor signals and to determine the position of the coupling elements and thereby the position of the moving element. The signal generator and the evaluation unit are preferably directly coupled so that the base signals used for the creation of the transmission signals are also use for evaluation of the receiver inductor signal, e.g., for synchronous detection and phase detection. Especially advantageous is for both units to be combined into one component that also advantageously is implemented as an integrated circuit (ASIC).

Determination of the moving element results over each measurement range here, whereby it may extend along a segment of a straight line (linear sensor), in a circle, or in an arc segment of a circle (rotation sensor), or a form differing from these configurations.

According to an extension of the invention, a device for redundant determination of the position of a moving element with respect to a stator element is formed in that the two inductive coupling elements are mounted on the moving element. The positions of the coupling elements, and redundantly, the positions of the moving elements may be determined from the receiver inductor signal. Function monitoring may result from comparison of the measurement values and determination of deviations.

An alternative determination device serves to determine the position of two moving elements with respect to a stator element. For this, one of the coupling elements is mounted on each of the moving elements. The positions of the coupling elements and thereby those of the moving elements are determined from the receiver inductor signal. In this manner, for example, differential motions may be simply and accurately determined. Since identical inductors and largely identical signal paths may be used, systemic errors may be minimized. Redundant determination may result by means of additional coupling elements.

According to an extension of the device to determine the position of two moving elements, the moving elements are mounted on axially-separated sections of a shaft that rotates with respect to the stator element. The shaft sections are connected to one another elastically so that they are rotated with respect to one another by torque on the shaft such that a motion differential of the moving elements results, i.e., that the relative alignment of the moving elements with respect to one another changes dependent on the torque applied to the shaft. The evaluation element in this case advantageously determines the motion differential that may serve as measurement of the torque applied.

In the following, the invention will be described in greater detail using Figures, which show:

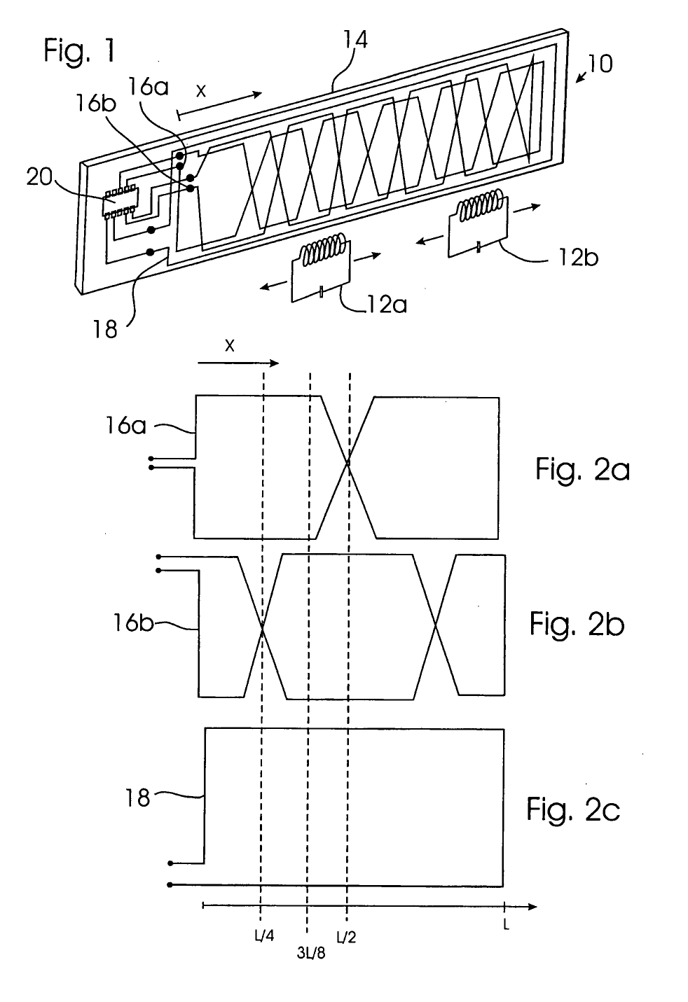

FIG. 1 is a schematic, perspective view of an inductive sensor with two inductive coupling elements and an inductor circuit.

FIGS. 2a-2c are schematic views of flat inductor topologies of a first exciter inductor, a second exciter inductor, and a receiver inductor.

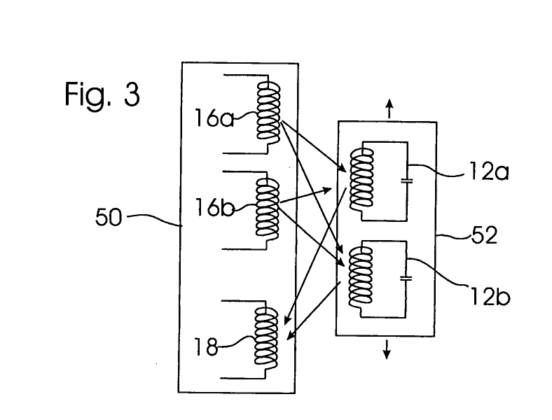

FIG. 3 is a schematic view of the interaction between two exciter inductors and one receiver inductor with two inductive coupling elements.

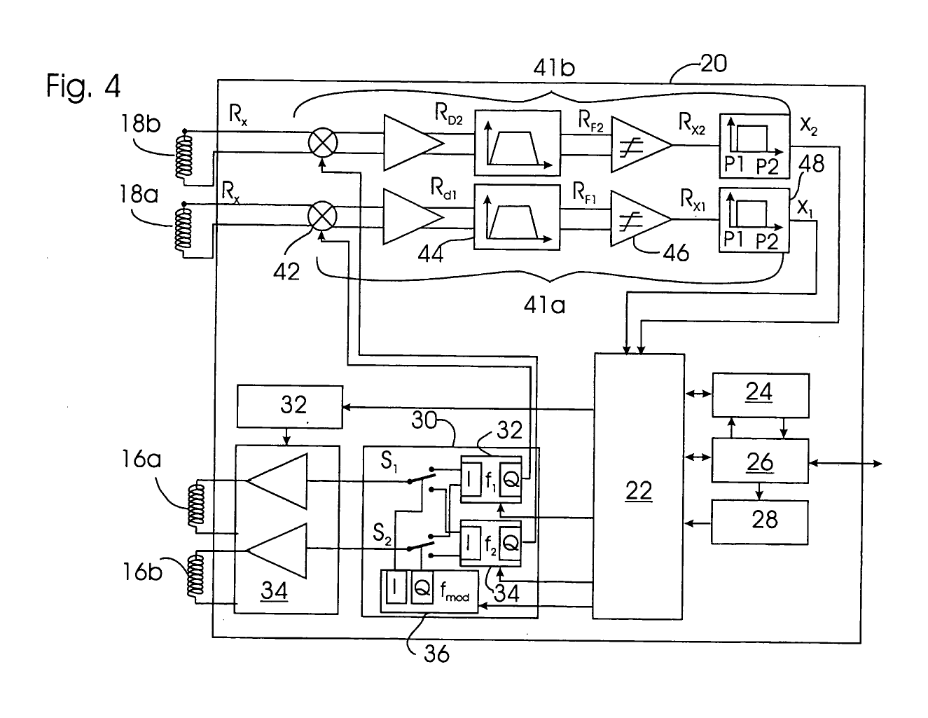

FIG. 4 is a symbolic view of elements of an electrical circuit with signal generator and evaluation unit.

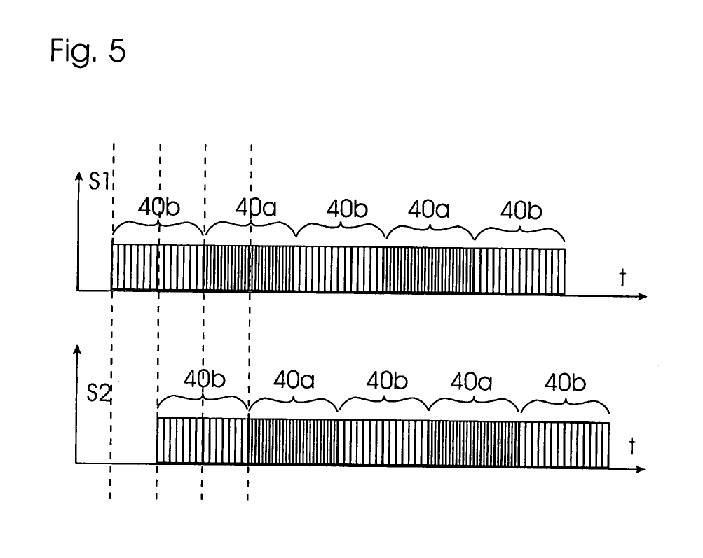

FIG. 5 is a diagram of temporal progressions of a first and a second transmission signal.

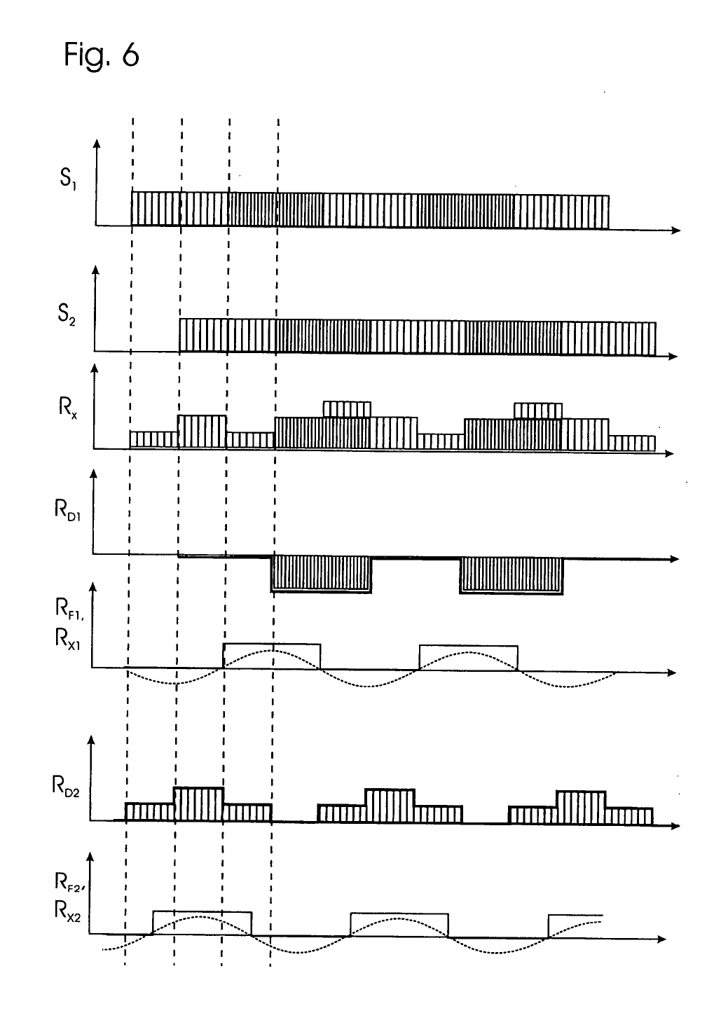

FIG. 6 is a diagram of temporal progressions of different signals of the circuit per FIG. 4.

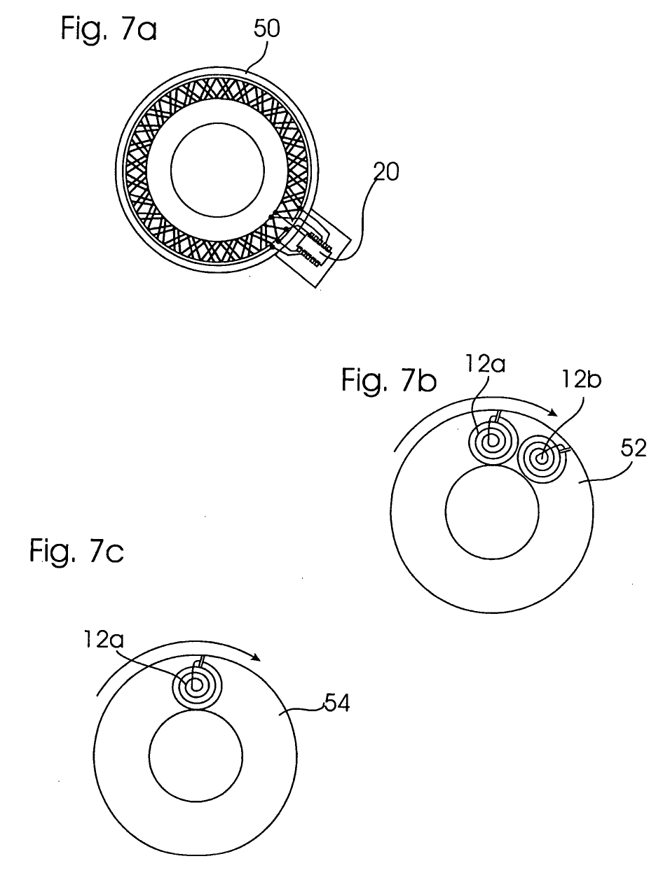

FIG. 7a is a schematic frontal view of a stator element of an inductive rotational-angle sensor.

FIG. 7b is a schematic frontal view of a first preferred embodiment of a rotor element of the inductive rotational-angle sensor per FIG. 7a.

FIG. 7c is a schematic frontal view of a second preferred embodiment of a rotor element of the inductive rotational-angle sensor per FIG. 7a.

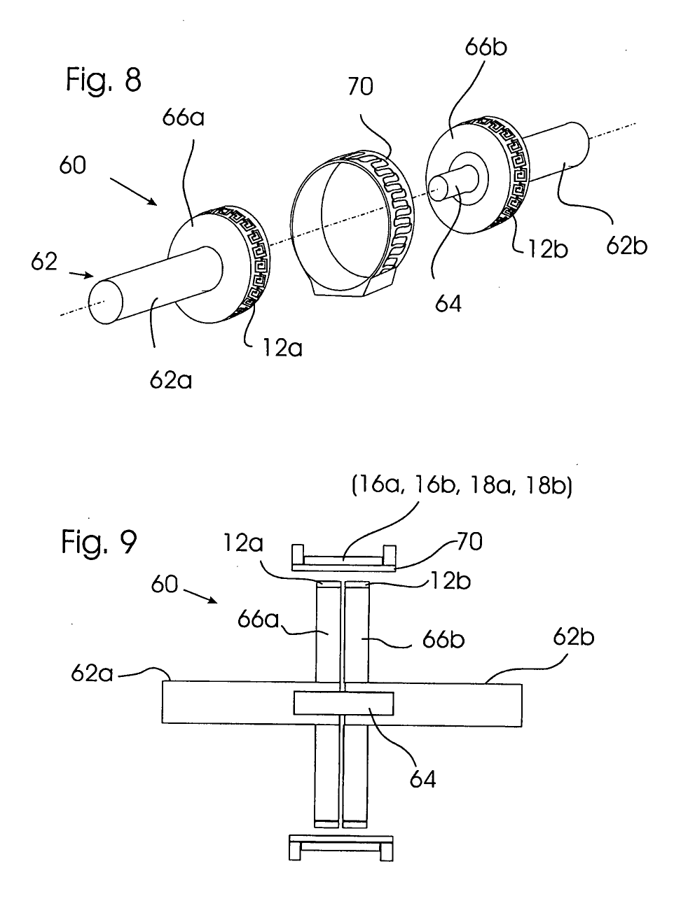

FIG. 8 is a perspective view of elements of a torque sensor on a shaft.

FIG. 9 is a schematic view of a longitudinal cutaway through the shaft with the torque sensor per FIG. 8.

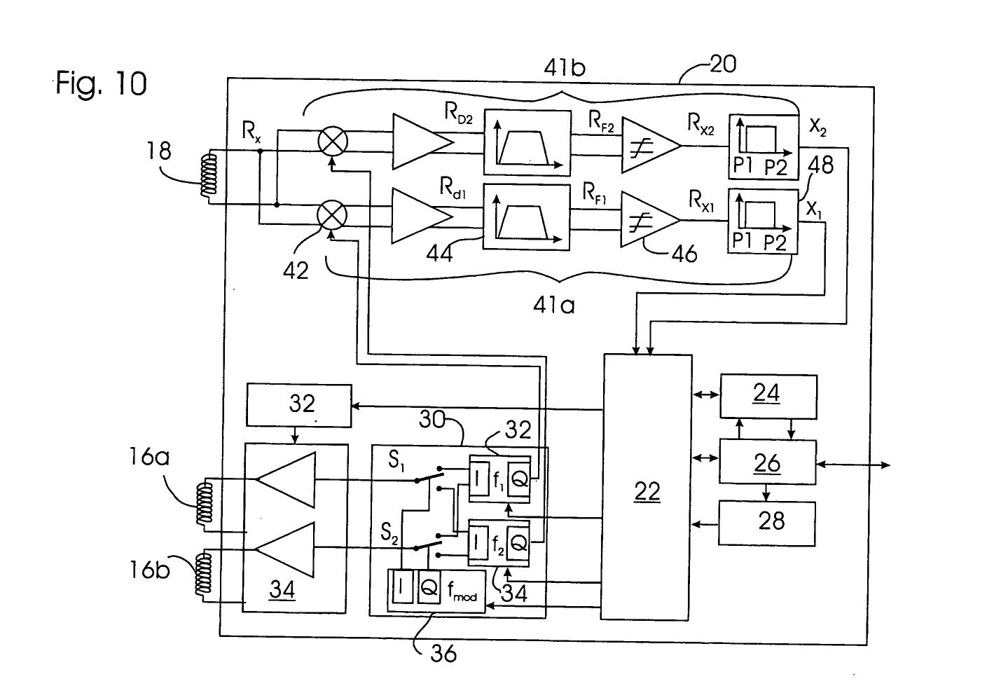

FIG. 10 is a symbolic view of elements of an alternative embodiment of an electrical circuit with signal generator and evaluation unit.

FIG. 1 shows schematically an inductive sensor device 10 by means of which the position of two coupling elements 12a, 12b along a linear measurement range X may be determined. A circuit board 14 bears an inductor circuit including a first exciter inductor 16a (sine inductor), a second exciter inductor 16b (cosine inductor), and a receiver inductor 18. All inductors are formed as flat conductor strips on the circuit board 14, and are connected with a driver and evaluation circuit (ASIC) 20.

The exciter inductors 16a, 16b extend in such a pattern along the linear measurement range X that a sine-wave varying magnetic field results along the X dimension from current flow through the inductors. For this, the inductors 16a, 16b are phase-shifted with respect to one another, which is why they are designated as a sine inductor or a cosine inductor.

The inductive coupling elements 12a, 12b are formed as resonance circuits with an inductance and a capacitance so that they possess a resonance frequency in the MHz range. The resonance frequencies of the two inductive coupling elements 12a, 12b are distinct from each other. In this example, the resonance frequency of the first coupling element 12a is f₁=2.6 MHz, and the resonance frequency of the second coupling element 12a is f₂=4 MHz.

The design of the inductor circuit (hereafter called Pad) with the exciter inductors 16a, 16b and the receiver inductor 18 and the coupling elements (hereafter called Puck) corresponds to the sensor described in the aforementioned WO 2003/038379 but with the difference that in this case two Pucks 12a, 12b are present instead of only one. Therefore, these elements will be described in the following only basically, and the reader is referred to the above-mentioned patent document for additional details.

FIGS. 2a-2c show an example of the routing of the conductor strips forming the inductors 16a, 16b, 18 that vary spatially along the X dimension of the measurement range. The inductors shown in FIGS. 2a-2c hereby include merely a single period that extends over the length L. By contrast, in the inductor circuit shown in FIG. 1, the pattern of spatially varying inductors 16a, 16b is repeated several times.

During operation of the sensor 10, the exciter inductors 16a, 16b are driven by the ASIC 20 with alternating-current transmission signals that contain signal components of a first carrier frequency f1 and a second carrier frequency f2. As is explained in the aforementioned WO 2003/038379 for one Puck, the magnetic field resulting from the two inductors 16a, 16b driven by the transmission signal excites each Puck 12a, 12b to resonance and leads to a (phase-shifted) receiver inductor signal in the receiver inductor 18 merely shaped as a conductor loop. The over-crossing structure of the exciter inductors 16a, 16b with spatially-varying positive and negative surface areas causes the inductor circuit to be in balance, so that a direct coupling of one of the transmission signals into the receiver inductor signals 18 is largely prevented. A signal Rx received at the receiver inductor 18 therefore passes onto the coupling back through the Pucks 12a, 12b.

FIG. 3 shows symbolically the interaction between the inductors 16a, 16b, 18 of the Pad with the Pucks 12a, 12b. Each of the two Pucks 12a, 12b is excited by means of the transmission signals of each of the two exciter inductors 16a, 16b. The signal resulting depending on excitation of both Pucks 12a, 12b is overlapped in the receiver inductor 18 to a summary signal Rx. Because of their design as resonance circuit, the Pucks 12a, 12b are hereby frequency-selective, i.e., the first Puck 12a is excited only by those components of the two transmission signals of the exciter inductors 16a, 16b that lie at (or sufficiently near) its resonance frequency f1. This is why the impacting components from the first Puck 12a of the summary signal Rx received in the receiver inductor 18 are returned correspondingly to the signal components at frequency f1. In mirror reflection, the same applies for the second Puck 12b and its resonance frequency f2.

In the following, the design and the manner the ASIC 20 functions will be explained. The ASIC 20, whose inner structure is shown symbolically in FIG. 4, serves on the one hand as a signal-generator to supply the exciter inductors 16a, 16b with each of their transmission signals. On the other hand, the ASIC 20 also serves as an evaluation circuit by means of which the receiver inductor signal received in the receiver inductors 18a, 18b is evaluated, and therefrom the positions of the Pucks 12a, 12b may be determined. Instead of a single receiver inductor 18, two receiver inductors 18a, 18b are provided, each of which is separately connected to signal-processing branches. The two branches 41a, 41b are separated from each other in this manner so that any potential signal influence is prevented. This justifies the slightly increased expense arising through the additional receiver inductor structure. The two separated receiver inductors 18a, 18b may be identical in shape and position, but it is advantageous to mount them near the pertinent two coupling elements so that the received signal of each pertinent coupling elements is received particularly well in each inductor.

The ASIC 20 includes a central processor 22 within which, as will be explained in the following, the specifications for the exciter inductor signals will is created, and in which the positional values contained in the receiver inductor signal are managed. The central processor 22 hereby operates with a memory buffer 24. Communication with the outside world occurs via an interface 26. A power-supply unit 28 serves to power the central processor 22. The interface 26 is preferably a current interface in which the prepared direct current to operate the ASIC 20 includes modulated (alternating-current) components within which data are encoded. The interface 26 passes the operating current to the supply unit 28, while modulated data are demodulated and passed to the buffer 24 or to the central processor unit 22.

A pattern generator 30, a transmission voltage supply 32, and a driver circuit 34 are provided at the transmission side of the ASIC 20. The exciter inductors 16a, 16b are connected to the driver circuit 34. The central processor unit 22 controls the pattern generator 30 to create two transmission signals S1, S2. The transmission signals S1, S2 are correspondingly amplified within the driver component 34 formed as a bridge driver. This driver component 34 is powered by the transmission-voltage supply 32 that then passes the transmission signals S1, S2 to the exciter inductors 16a, 16b.

Within the pattern generator 30, a first oscillator 32 provides a digital oscillator signal (pulse signal) at frequency f1. This signal is passed first in proper phase via an output I, and also phase-displaced by 90° to an output Q. In the same manner, a second oscillator 34 provides a digital oscillator signal at frequency f2.

A third oscillator 36 also provides a digital oscillator signal first in proper phase (I) and a second digital oscillator signal that is phase-displaced by 90° (Q) at a frequency of f_{mod}. The modulation frequency is considerably lower in frequency than the carrier frequencies f1, f2. Preferably, f_{mod} is selected within the kHz band, and in the illustrated example, f_{mod}=4 kHz. While oscillators 32, 34, 36 are shown as separate units at different frequencies in FIG. 4, it is advantageous for all of the oscillation signals be generated from a common basic cycle. In the illustrated example, this is 16 MHz. From this, the central processor 22 generates the signals for the oscillators by means of suitable frequency dividers.

Within the pattern generator 30, the transmission signals S1, S2 are created from the oscillator signals. For the first transmission signal S1 (intended for the first exciter inductor 16a), the two oscillator signals are mixed digitally with the proper-phase (I) modulation signal. To generate the second transmission signal S2 intended for the second exciter inductor 16b, a digital mixing of the two carrier signals occurs, but with the phase-shifted (Q) modulation signal. This digital mixing of the oscillator signals at the carrier frequencies f1, f2 occurs in the illustrated example as especially advantageous if alternating, i.e., each of the signals S1, S2 consist of alternating signal components of the first carrier f1 and of the second carrier frequency S2.

FIG. 5 schematically shows the temporal progression of the transmission signals S1 and S2. Each of the signals is comprised of first signal extracts 40a of the first carrier frequency f1, and secondly signal extracts 40b of the second carrier frequency f2 in an alternating manner. Each of the extracts follows periodically. Each of the two extracts form a period of the modulation frequency f_{mod}.

As is visible in FIG. 5, the transmission signals S1, S2 are involved as completely modulated versions of the oscillator signals on the two frequencies f1, f2. The moments in time during which each signal component is completely switched out corresponds to digital multiplication times zero. The switched-on areas correspond to digital multiplication times one. Thus, the modulated signal of both frequencies is constantly and uninterruptedly present within both signals S1, S2. The signal components on both carrier frequencies are thus actually transmitted simultaneously. Correspondingly, continuous excitation of the Pucks 12a, 12b results, so that the position may not only be determined periodically, but rather to the extent possible within the digital domain-continuously.

The exciter inductors 16a, 16b are driven by the thus-formed transmission signals. The magnetic fields generated from this excite the resulting magnetic field of each of the Pucks 12a, 12b. For this, those signal components that correspond to the resonance frequency of each Puck lead to an increase in resonance, and thus to a reflected signal that is received by the receiver inductors 18a, 18b.

As the aforementioned WO 2003/038379 explains in detail, the phase status (with respect to the modulation frequency f_{mod}) of the reflected signal is dependent on the position of the Puck within the measurement range. This is correspondingly the case for a sensor with two Pucks. If one omits the selected digital implementation in this example, and instead assumes continually sine-shaped time progressions, then the receiver inductor signal Rx reflected from the Pucks and received in the receiver inductors 18a, 18b for a position x1 (within the measurement range 0-L, see FIGS. 2a-2c) of the first Puck 12a and a position x2 of the second Puck 12b corresponds to the equation

$${R}_{x} = cos 2 π {f}_{1} t cos ( 2 π {f}_{mod} t - 2 π \frac{x 1}{L} ) + cos 2 π {f}_{2} t cos ( 2 π {f}_{mod} t - 2 π \frac{ x 2}{L} ) + sin 2 π {f}_{1} t sin ( 2 π {f}_{mod} t - 2 π \frac{x 1}{L} ) + sin 2 π {f}_{2} t sin ( 2 π {f}_{mod} t - 2 π \frac{x 2}{L} )$$

The receiver inductor signal Rx thus consists of an additive overlay of two terms, of which the first is a modulated version of a signal component for the first carrier frequency, and (in its phase with respect to f_{mod}) and indicates the position x1 of the first Puck 12a, and correspondingly the second term is a modulated signal of the second carrier frequency f2, and contains the information regarding the position x2 of the second Puck 12b in its phase.

The receiver inductor signal Rx is processed within the ASIC 20, and is evaluated regarding the position information x1, x2 contained within it. In the illustrated example, the processing occurs in two parallel, identical branches 41a, 41b, from which only the first branch 41a shown in FIG. 4 will be described. The receiver inductor signal Rx is mixed in a mixer 42 with the complementary signal Q of the first carrier frequency, which corresponds to synchronous rectification of the signal components at this frequency. The signal R_{D1} demodulated with respect to the frequency f1 is amplified, and is filtered within a band-pass filter 44, to obtain a filtered signal R_{F1}. The analogous, sine-shaped signal R_{F1} [is converted to] a detection signal R_{X1} by the threshold-value detector 46. The frequency of the digital signal R_{X1} corresponds to the modulation frequency f_{mod}. The phase status of the signal R_{X1} is determined within a phase detector 48, which very simply may occur by means of a digital counter, as described in the Patent Publication No. WO 2003/038379. This provides a scale for the position x1 of the first Puck 12a, and is passed to the central processor unit 22.

In the same manner, the receiver inductor signal Rx within the second branch 41b is processed with respect to the second modulation frequency f2. By means of the signal processing matched to the various carrier frequencies f1, f2 within the two branches 40a, 40b, the frequency mixture within the signal Rx is effectively separated again so that two separate signals R_{X1}, R_{X2} are determined from whose phase the positions x1, x2 may be determined.

The signal processing will be described in the following example of signal progression shown n FIG. 6. For this, the transmission signals S1, S2 are shown in the two upper diagrams. The third diagram shows the receiver inductor signal represented symbolically that contains signal components for the first carrier frequency f1 as well as those for the second carrier frequency f2. The component of the first carrier frequency f1 from this summary signal Rx is processed by the first processing branch 41a of the ASIC 20. Demodulation and band-pass filtering produces the envelope-filtered signal R_{D1} reflected back to the first Puck 12a. The filtered signal R_{F1} (shown by dashed line) is created by means of filtering. In the same manner, the second branch 41b of the receiver inductor portion of the ASIC 20 delivers the envelope-filtered signal R_{D2} reflected back to the second Puck 12b that is attributed to the position of the second Puck 12b from which the filtered sine-shaped signal (dashed line) arises as a result of deep-pass filtering.

The filtered signals R_{F1} R_{F2} are converted into digital comparator signals R_{X1} R_{X2} by the threshold-value detector 46 (shown with a broken line). The phase status of these digital signals may be determined particularly simply in that, based on the start of the period (whose point in time is known from the signal from the oscillator 36 of the modulation frequency f_{mod}), a continuous counter counts the time up to the flank change of the comparator signals R_{X1} R_{X2}. The counter values x1, x2 thus obtained show the positions of the Pucks 12a, 12b. In this manner, the position of two Pucks independent from each other along the measurement range may be determined using a single Pad.

This may on the one hand be used to advantage to obtain redundancy during determination of the position. This is shown schematically in FIG. 3. In the illustrated case, a single receiver inductor 18 is provided instead of separate receiver inductors 18a, 18b. The three inductors 16a, 16b, 18 forming the Pad are mounted on a stator element 50. A moving element 52 moves linearly with respect to the stator element 50. The two coupling elements 12a, 12b are mounted firmly on the moving element 52. The signal processing shown at the top determines two measurement values for the motion of the moving element 52, which agree in the case of proper function (seen from the different mounting positions shown in the illustrated example).

Error functions may be easily recognized in this manner because of deviations from the determined values.

Instead of a linear sensor shown in FIG. 1, a rotational-angle sensor may be realized by simply using the described sensor principle. FIG. 7 shows schematically a corresponding stator part 50 in the form of a circuit board with the inductor circuit mounted on it (Pad), which is connected to an ASIC 20. The conductor strips, as FIG. 7 shows symbolically, also here form two spatially varying exciter inductors and one receiver inductor formed as a conductor loop, whereby the inductor design is positioned along the ring-shaped (in this case) measurement range.

A first implementation of a rotor 52 may be assigned on the one hand to the stator 50, as FIG. 7b shows. The rotor 52 is mounted concentrically on the stator [50]. It bears two Pucks 12a, 12b. The rotor 52 may rotate along the arrow direction with respect to the stator 50. The (rotational) position of the Pucks 12a, 12b may be determined by means of the evaluation circuit 20. The rotational position of the rotor 52 with respect to the stator 50 may be determined redundantly.

In an alternative embodiment, a rotor 54 bears merely one Puck 12a. However, two rotor elements 54 are present, whereby the second rotor element (not shown) bears the second Puck 12b. The two rotor elements are positioned on both sides of the ring-shaped Pad, and each may rotate independently of each other with respect to the stator 50. The rotational positions of both rotor elements may now be queried.

As an alternative potential application of the described sensor principle, FIGS. 8 and 9 show an inductive torque sensor 60, such as might be mounted on the steering shaft of an automobile. One shaft 62 consists of a first shaft segment 62a and a second shaft segment 62b that are connected via an elastic section 64 such that they rotate opposite each other when torque is applied. A wheel-shaped first rotor element 66a is mounted on the first shaft section 62[a], and an identically-shaped second rotor element 66b is mounted on the second shaft section 62b. These rotors bear an inductor structure about their circumference, whereby the ends of the inductor structure are connected by means of a capacitor so that a resonance circuit is formed. The inductor structures of the two rotors 66a, 66b are identical, but configuration with different capacitors provides resonance elements 12a, 12b with different resonance frequencies.

A ring-shaped stator 70 is provided along whose circumference an inductor circuit (Pad with two separate receiver inductors 18a, 18b, as described above) is mounted that is connected to an ASIC (not shown).

The sensor 60 now forms an inductive sensor, as described above. The resonance elements 12a, 12b on the rotor elements 66a, 66b move with respect to the Pad with the inductors 16a, 16b, 18a, 18b on the ring-shaped stator 70. Using the signal evaluation described above, the rotational position of the two Pucks 12a, 12b may be determined independently of each other. On the one hand, these values may be used on a steering shaft to detect the steering angle. On the other hand, a differential in the determined values indicate a torque on the shaft 62 since only such would lead to rotational displacement of the rotors 66a, 66b opposite each other.

The rotational-angle and torque sensor 60 thus formed provides processing that is simple and especially suited to digital signal processing and with low expense that ensures positive determination of all motion data of the shaft 62.

In addition to the illustrated preferred embodiments, a number of extensions or modifications are conceivable:
The position of more than just two Pucks can also be determined. In order to combine the advantages of differential measurement with those of redundant determination, two pads may be driven with two assigned Pucks, for example.
Alternatively to the signal processing with two separate receiver inductors 18a, 18b shown in FIG. 4, it is also possible per FIG. 10 to capture the signals reflected from the Pucks 12a, 12b using only one receiver inductor 18 and then to process the receiver inductor signal Rx in the two separate branches 41a, 41b separately. In order to compensate for potential measurement errors that might result from a deviation between the carrier frequencies f1, f2 used and the actual resonance frequencies of the Pucks 12a, 12b caused by potential environmental influences, it is possible to perform the correctional measurement described in the Patent Publication No. WO 2003/038379 using one opposing-phase signal so that the phase shift caused here may be compensated. However, in the case where merely the differential values are of interest, (torque sensor), this may be eliminated since a (constant, additive) phase shift has no influence here.
As described in the Patent Publication No. WO 2003/038379, both inductor structures deviating from the illustrated geometric structure and exciter inductor signals deviating from the illustrated time progression may be used.
While the measurement range in FIGS. 2a-2c includes merely one single period of the periodically-varying inductors 16a, 16b up to the length L, it is advantageous, as shown for example in FIGS. 1, 7a, and 8, to divide them into multiple periods. In order to prevent the aliasing (ambiguity) problem that may arise, it is possible on the one hand to track the position of the Puck continuously and to collect the number of passed periods using a counter. On the other hand, it is possible to operate using two Pads of different configuration, whereby, for example in the torque sensor from FIGS. 8 and 9, the stator 70 bears two inductor structures with different configuration instead of merely one inductor structure. Since each combination of measurement values of the first and of the second inductors structures is unique along the measurement range, ambiguity may be avoided.

What is claimed is:

1. Inductive sensor device comprising:
a first and a second exciter inductor that extend along a measurement range and vary spatially differently from each other,
a receiver inductor,
a first and a second inductive coupling element to tightly couple a signal from the exciter inductors into the receiver inductor, the inductive coupling elements being formed as resonance element, whereby the first inductive coupling element includes a first resonance frequency, and the second inductive coupling element includes a second resonance frequency,
wherein the first exciter inductor is driven by a first transmission signal and the second exciter inductor is driven by a second transmission signal,
wherein each of the transmission signals includes signal components of a first carrier frequency alternating in temporal progression and signal components of a second carrier frequency alternating in temporal progression, and
wherein the two transmission signals differ from each other with respect to the temporal progression.

2. Device as in claim 1, wherein:
the signal components of the first and of the second carrier frequency within the transmission signals are altered according to a modulation frequency,
the two transmission signals are different from the modulation frequency in phase.

3. Device as in claim 1, wherein:
the transmission signals are formed as temporally successive first and second signal extracts,
the first signal extracts are formed as oscillations of the first carrier frequency and the second signal extracts are formed as oscillations of the second carrier frequency,
the progression of signal extracts results in cycles of a modulation frequency, and
the signal extracts of the two transmission signals are temporally displaced with respect to each other.

4. Device as in claim 1, wherein:
at least one of the receiver inductors is connected to an evaluation unit to evaluate a receiver inductor signal, from which the position of the coupling elements is determined, and
the evaluation unit is configured such that the receiver inductor signal is demodulated in order to obtain a first and a second demodulated signal whose frequency essentially corresponds to the modulation frequency, whereby the position of the coupling elements may be determined from the phase of the demodulated signal.

5. Device as in claim 1, for redundant determination of the position of a moving element with respect to the stator element, wherein:
the stator element includes an inductive circuit with the exciter inductors and at least one receiver inductor,
the moving element includes the two inductive coupling elements,
the exciter inductors are connected to a signal generator to create and supply the transmission signals, and
the receiver inductor is connected to an evaluation unit to evaluate a receiver inductor signal from which the position of the moving element is determined.

6. Device as in claim 1, to determine the position of two moving elements with respect to a stator element, wherein:
the stator element includes an inductive circuit with the exciter inductors and at least one receiver inductor,
each of the moving elements comprises one of the coupling elements,
the exciter inductors are connected to a signal generator to create and supply the transmission signals, and
the receiver inductor is connected to an evaluation unit to evaluate an receiver inductor signal from which the position of the moving element is determined.

7. Device as in claim 6, wherein:
the moving elements are so positioned along axially-separated sections of a shaft that they rotate with respect to the stator element as the shaft rotates,
the shaft sections are elastically connected so that they rotate in opposite directions as torque is applied to the shaft such that a motion differential of the moving elements results, and
the evaluation unit determines the motion differential.

8. Method for inductive identification, wherein:
a first and a second exciter inductor that extend along a measurement range and vary spatially differently from each other are driven by differing transmission signals, whereby the first exciter inductor being driven by a first transmission signal and the second exciter inductor being driven by a second transmission signal,
a first and a second inductive coupling element are positioned to couple a signal from the exciter inductors into at least one receiver inductor, the inductive coupling elements being formed as resonance elements, with the first coupling element possessing a first resonance frequency and the second coupling element possesses a second resonance frequency,
each of the transmission signals include signal components of a first carrier frequency near the first resonance frequency alternating in temporal progression, and signal components of a second carrier frequency near the second resonance frequency, and
the two transmission signals possess different temporal progressions.
